(19) United States
(12) Patent Application Publication
(10) Pub. No.: US 2025/0031173 A1
(43) Pub. Date: Jan. 23, 2025

(54) METHODS, APPARATUSES, AND COMPUTER PROGRAMS FOR SELECTING A LOCATION MANAGMEMENT FUNCTION FOR A REQUESTED LOCATION SERVICE

(71) Applicant: Nokia Technologies Oy, Espoo (FI)

(72) Inventors: Laurent THIEBAUT, Massy (FR); Mao CAI, Chengdu (CN); Shubhranshu SINGH, Munich (DE); Sankaran BALASUBRAMANIAM, Bangalore (IN)

(21) Appl. No.: 18/447,021

(22) Filed: Aug. 9, 2023

(30) Foreign Application Priority Data
Jul. 19, 2023 (CN) 202310884894.4

(51) Int. Cl. H04W 64/00

(52) U.S. Cl. CPC H04W 64/00

(57) ABSTRACT

An apparatus comprising circuitry configure to: receive a location request for a location of at least one user equipment, the location request comprising an identifier associated with a group of user equipment or information for determining the identifier associated with the group of user equipment. The circuitry is further configured to, based on determining that the at least one user equipment belongs to the group of user equipment, transmit, towards a network repository function, a discovery request for causing the network repository function to discover and select, based on the identifier associated with the group of user equipment, a location management function that serves the at least one user equipment, the discover request comprising the identifier associated with the group of user equipment and receive, from the network repository function, the identifier of location management function that serves the user equipment

### CROSS-REFERENCE TO RELATED APPLICATIONS

This patent application claims the benefit of priority of Chinese Patent Application No. 202310884894.4 filed Jul. 19, 2023, which is hereby incorporated by reference as if reproduced in its entirety.

### TECHNICAL FIELD

The examples and non-limiting example embodiments of the subject matter described herein relate generally to wireless communication systems and, more particularly, to methods and apparatuses which use an identifier associated with a group of user equipment, such as an identifier of a group of user equipment or an identifier of a network slice for a group of user equipment, to select a location management function (LMF) of the wireless communication system for positioning (e.g., determining a location of) at least one user equipment.

### BACKGROUND

It is known for a wireless communication system to determine a position (e.g., a location) of a user equipment communicating with a wireless communication system.

### SUMMARY

In accordance with an aspect, an apparatus includes: at least one processor; and at least one memory storing instructions that, when executed by the at least one processor, cause the apparatus at least to perform: receiving, from an access and mobility management function, a location request for a location of at least one user equipment belonging to a group of user equipment; based on determining that the at least one user equipment belongs to the group of user equipment, transmitting, towards a network repository function, a discovery request for causing the network repository function to discover and select, based on the identifier associated with the group of user equipment, a location management function that serves the user equipment, the discover request comprising the identifier associated with the group of user equipment; and receiving, from the network repository function, the identifier of location management function that serves the at least one user equipment.

In accordance with an aspect, an apparatus includes: at least one processor; and at least one memory storing instructions that, when executed by the at least one processor, cause the apparatus at least to perform: receiving, from an access and mobility function, a discovery request for discovering and selecting a location management function that serves at least one user equipment, the discovery request comprising an identifier associated with a group of user equipment, wherein the at least one user equipment belongs to the group; discovering and selecting, based at least on the identifier associated with the group of user equipment, an identifier of the location management function that serves the at least one user equipment; and transmitting, to an access and mobility management function, the identifier of the location management function.

In accordance with an aspect, an apparatus includes: at least one processor; and at least one memory storing instructions that, when executed by the at least one processor, cause the apparatus at least to perform: receiving a service request for a location of at least one user equipment, the request comprising information for determining an identifier associated with a group of user equipment, wherein the at least one user equipment belongs to the group; determining the identifier associated with the group of user equipment based on the information for determining the identifier associated with the group of user equipment; and transmitting, towards an access and mobility function, a location request for the location of the at least one user equipment, the location request comprising the identifier associated with the group of user equipment, the location request configured for causing the access and mobility function to obtain the location of the at least one user equipment and provide the location of the user equipment to network function.

In accordance with an aspect, an apparatus includes: at least one processor; and at least one memory storing instructions that, when executed by the at least one processor, cause the apparatus to perform at least: receiving, from an access and mobility management function, a location request for a location of at least one user equipment belonging to a group of user equipment; and transmitting, to the access and mobility management function, a response to the location request, the response comprising a location of the at least one user equipment belonging to the group of user equipment.

### BRIEF DESCRIPTION OF THE DRAWINGS

The foregoing aspects and other features are explained in the following description, taken in connection with the accompanying drawings.

FIG. 1 is a block diagram of one possible and non-limiting wireless communication system in which the example embodiments may be practiced.

FIG. 2 depicts a diagram of a location request procedure.

FIG. 3 is an example apparatus configured to implement the examples described herein.

FIG. 4 shows a representation of an example of non-volatile memory media used to store instructions that implement the examples described herein.

FIG. 5 is an example method, based on the examples described herein.

FIG. 6 is an example method, based on the examples described herein.

FIG. 7 is an example method, based on the examples described herein.

FIG. 8 is an example method, based on the examples described herein.

### DETAILED DESCRIPTION OF EXAMPLE EMBODIMENTS

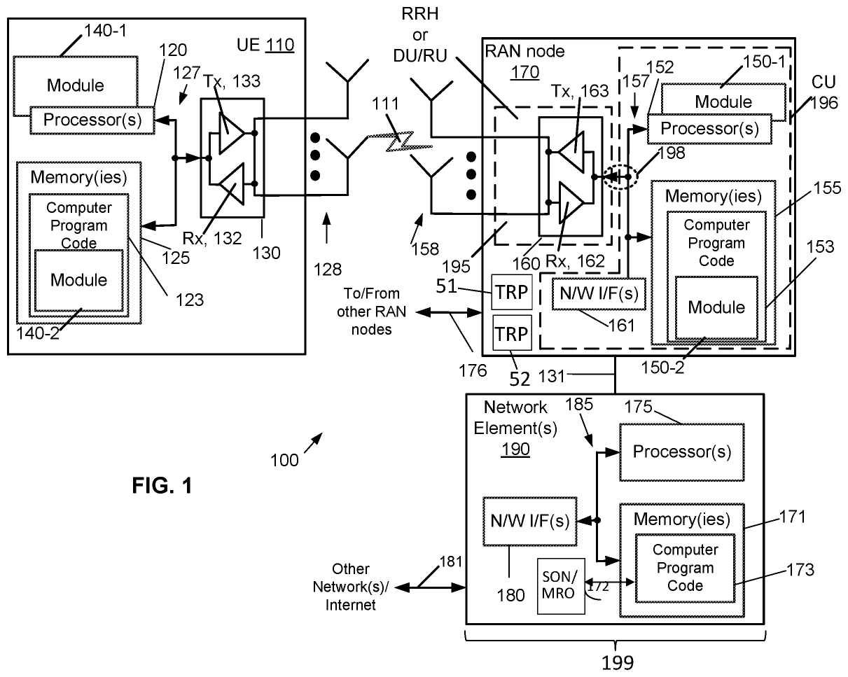

Turning to FIG. 1, this figure shows a block diagram of one possible and non-limiting example of a wireless communication system in which the examples may be practiced. The wireless communication system comprises a user equipment (UE) 110, a radio access network (RAN) comprising one or more RAN nodes 170, and a core network 199 comprising one or more network element(s) 190. In the example wireless communication system shown in FIG. 1, the user equipment (UE) 110 is in wireless communication with a wireless network 100. The UE 110 is a wireless communication device that can access and is in communication with the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include or store computer program code 123. In some embodiments, the UE 110 may include a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a field programmable gate array. In another example, the module 140 may be implemented as module 140-2, which comprises computer program code 123 having instructions which are executable by the one or more processors 120. For instance, the one or more memories 125 and the computer program code 123 may be configured to, with the one or more processors 120, cause the user equipment 110 to perform one or more of the operations as described herein. The UE 110 communicates with a RAN node 170 of a radio access network (RAN) of the wireless network 100 via a wireless link 111 (generally referred to as a Uu link).

The RAN node 170 in this example is a base station that provides access for wireless communication devices such as the UE 110 to the core network 199 of the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to the core network 199, which may be, for example, a 5G core network (5GC). The ng-eNB is a node providing E-UTRA user plane and control plane protocol terminations towards the UE 110, and connected via the NG interface (such as connection 131) to the core network 199, which may be, for example, a 5GC or an evolved packet core (EPC), or comprise both a 5GC and an EPC. The NG-RAN node may include multiple gNBs, which may also include a central unit (CU) (gNB-CU) 196 and one or more distributed units (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 provides, for one or multiple cells, support for the higher layers of the protocol stack such as SDAP, PDCP and RRC. One cell may be supported with one gNB-DU 195, or one cell may be supported/shared with multiple DUs when a RAN is shared by multiple network operators. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 may include a module 150. The module 150 may be implemented as module 150-1, which comprises hardware, such as the one or more processors 152 and the one or more memories 155 of the RAN node 170, and software (e.g., computer program code 153) stored in the one or more memories 155. In another example, the module 150-1 may be semiconductor chip such as an integrated circuit (e.g., an application specific integrated circuit ASIC) or field programmable gate array (FPGA) comprising firmware. In another example, the module 150 may be module 150-2, which comprises only software, such as computer program code 153. In this example, the module 150-2 is stored in the one or more memories 155 of the RAN node 170 and the module 150-2 and instructions of the module 150-2 (e.g., instructions of the computer program code 153) may be executed by the one or more processors 152 of the RAN node 170. For example, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be a wired link or a wireless link or both and may implement, for example, an Xn interface for 5G, an X2 interface for LTE, or other suitable interface for other radio access technologies defined in standards provided by the 3^{rd} Generation Partnership (3GPP).

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 when the RAN node 170 is an eNB or a distributed unit (DU) 195 when the RAN node 170 is a gNB, with the other elements of the RAN node 170 possibly being physically in a different location from the RRH and/or DU 195, and the one or more buses 157 could be implemented in part as, for example, fiber optic cable or other suitable network connection to connect the other elements (e.g., a central unit (CU), gNB-CU 196) of the RAN node 170 to the RRH and/or DU 195. Reference 198 also indicates those suitable network link(s).

A RAN node (e.g., a gNB) can comprise one or more TRPs. FIG. 1 shows that the RAN node 170 comprises two TRPs, TRP 51 and TRP 52. The RAN node 170 comprise other TRPs not shown in FIG. 1.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one third of a 360 degree area so that the single base station's coverage area covers an approximate oval or circle. Furthermore, each cell can correspond to a single carrier and a base station may use multiple carriers. Thus, if there are three 120 degree cells per carrier and two carriers, then the base station has a total of 6 cells.

The wireless network 100 may include a core network 199 that includes a network element 190 or network elements 190. A network element 190 may include or implement one or more control plane network functions of the core network 199 and user plane network functions which provides connectivity via an interface and a link or links 181 with a further network, such as a telephone network and/or a data network (e.g., a packet data network or the Internet). Examples of control plane network functions for a 5G core network (5GC) include location management functions (LMF(s)), access and mobility management function(s) (AMF(S)), session management function(s) (SMF(s)), a network repository function (NRF, a universal data management (UDM) function, and a network exposure function (NEF). Examples of control plane network functions of an LTE core network include MME (mobility management entity), or a SGW (serving gateway). The core network 199 may also include core network functionality such as SON (self-organizing/optimizing network) functionality. These are merely example core network functions that may be included or implemented in the core network 199, and note that both 5G and LTE core network functions might be included in the core network 199. The RAN node 170 is coupled via a link 131 (e.g., a backhaul link) to the core network 199. The RAN node 170 and/or the core network may include an NG interface for 5G, or an SI interface for LTE, or other suitable interface for other radio access technologies for communications therebetween. The core network 199 may include one or more apparatuses, and any of the one or more apparatuses may comprise one or more processors 175, one or more memories 171, and one or more network interfaces (N/W I/F(s)) 180, interconnected through one or more buses 185. The one or more memories 171 include or store computer program code 173. Computer program code 173 may include SON and/or MRO functionality 172.

The core network 199 of the wireless network 100 may implement network function virtualization, which is the process of combining hardware resources and software resources and network functionality into a single, software-based entity, or a virtual network function. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g., a drone, or a UE mounted in a UAV. The user equipment 110 may be terminal device, such as mobile phone, mobile device, sensor device etc., the terminal device being a device used by the user or not used by the user.

UE 110, RAN node 170, and/or the core network 199, (and associated memories, computer program code and modules) may be configured to implement (e.g., in part) the methods described herein. For example, the core network 199 may use information related to a group of user equipment to select an LMF to be used for positioning UEs of the group of UEs. The computer program code 123, module 140-1, module 140-2, and other elements/features shown in FIG. 1 of UE 110 may implement user equipment related aspects of the examples described herein. Computer program code 173 and other elements/features shown in FIG. 1 of network element(s) of the core network 199 may be configured to implement network element related aspects of the examples described herein.

Having thus introduced a suitable but non-limiting technical context for the practice of the example embodiments of the present disclosure, the example embodiments of the present disclosure are now described with greater specificity.

The examples described herein are directed to a problem specified in key issue #3 of the eLCS study item described in 3GPP Rel.18 TR 23.700-71 entitled “Local Area Restriction for an LMF and GMLC” which states “In some scenarios, an GMLC and an LMF might be restricted to supporting location services in a local area, i.e., the LMF needs to be selected within the same local area of the GMLC. The objective of this KI is to investigate how to support the local area restriction for GMLC and LMF.”

The eLCS study item mentioned above describes the possibility of assigning service-related and location-based GMLC and LMF instances to support the case of a network operator that deploys a dedicated GMLC and LMF at the premises of a corporation (and with possibly some joint OAM shared with the corporation). The intent of assigning service-related and location-based GMLC and LMF instances is to support dedicated corporate location services.

The issue with this approach is that a dedicated GMLC and LMF at the premises of a corporation may result in the dedicated GLMC and LMF being selected for users that are not members of the corporation. These could be users that are just passing by or being present in that location for a short time.

In cases like public conferences, music concerts, etc., a solution should distinguish between genuine users of a location service and irrelevant users of the location service (e.g., users that may be passing by).

Without service-related group information (e.g., information about a group of users that is related to a service), the usage of a dedicated GMLC and LMF for location services bounded in the same defined area may have unexpected side-effect of the dedicated GMLC and LMF serving one or more irrelevant users, which results in using capabilities committed for corporate usage for non-corporate users. This may also induce delivery of a wrong service or service degradation to users who have subscribed to that service.

Hence, location services (LCS) performed in the area-bounded GMLC and LMF (e.g., a GMLC and LMF that are restricted to supporting location services in a given area) may not always be valid. The present application proposes a solution that handles such cases.

The examples described herein address the above problem, including providing many options for group correlation and usage in location services.

According to an aspect of the present disclosure, an identifier associated with a group of user equipment (generally referred to herein as an identified associated with a UE group) is used by an access and mobility function (AMF) of a core network to select a proper location management function (LMF) for a requested location service (LCS). In some embodiments, the identifier associated with a group of user equipment may be an identifier of a group of user equipment. The identifier of a group of user equipment (generally referred to herein as UE group ID of a UE group) identifies a group of user equipment including one or more user equipment. The location request may be to obtain a location of the one or more user equipment included in the group of user equipment identified by the UE group ID for the requested LCS. In some embodiments, the identifier associated with a group of user equipment may be an identifier of a network slice associated with the group of user equipment. The identifier of a network slice (generally referred to as a network slice ID associated with a UE group) identifies a network slice that has been allowed by a core network (e.g., AMF) of a wireless communication system and serves a group of user equipment including one or more user equipment. For this purpose i) the identifier associated with a UE group (e.g., UE group ID or network slice ID) is added to LMF related registration and discovery information that is stored in a NRF (network slicing information is defined as NF related NRF registration and discovery information), ii) based on multiple criteria, the AMF determines whether a group of user equipment (e.g., the UE group ID of a UE group or the network slice ID associated with the UE group) is to be related with a LCS request, and uses the identifier associated with a UE group (e.g., the UE group ID of a UE group or a network slice ID associated with the UE group) to select a LMF for a requested LCS, iii) to support this determination a core network of a wireless communication system may store a table associating tracking areas and/or cells with one or more identifiers associated with a UE group (e.g., a UE group ID of a UE group or a network slice ID associated with a UE group).

MT-LR Procedure with Group Information

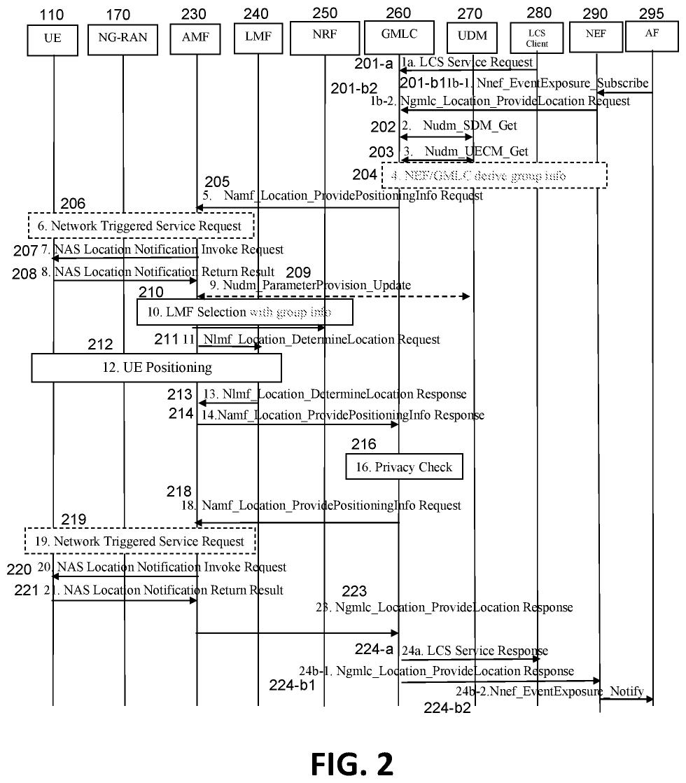

As used herein, an identifier of a network slice (e.g., a network slice ID) associated with a UE group may be single network slice assistance information (S-NSSAI) as defined in 3GPP TS 23.501. Referring to FIG. 2, a diagram of an MT-LR procedure in accordance with an example embodiment of the present disclosure is shown.

At 0 (not shown), one or more LMFs (otherwise referred to a LMF instance(s)) register their profile (generally referred to herein LMF profile) with NRF 250 (using for example, an Nnrf_NFManagement_NFRegister message defined in TS 23.502 clause 5.2.7.2.2). The profile (e.g., LMF profile) of respective LMFs registered with the NRF 250 includes one or more identifiers associated with a group UEs that the respective LMF is meant to serve. For example, the profile of a respective LMF includes one or more UEs that belong to a group of UEs that the respective LMF is meant to serve. A group of UEs is generally referred to herein as a UE group and a UE group includes one or more UEs). A UE group that one or more UEs belong to are identified by an identifier associated with the UE group (e.g., UE group ID of the UE group or a network slice ID associated with the UE group). The profile of a respective LMF also includes an identifier of the respective LMF is mean to serve. The profile of a respective LMF stored in the NRF 250 may include LMF related NRF registration and discovery information as defined in 3GPP TS 23.510, Table 6.1.6.2.46-1, where the identifier associated with a group of user equipment is added to LMF related NRF registration and discovery information is LmfInfo. Thus, the MF related NRF registration and discovery information includes an identifier associated with a group of user equipment.

At 10 (210), the AMF 230 issues Nnrf_NFDiscovery_Request defined in TS 23.502 clause 5.2.7.3 providing the identifier associated with a UE group (e.g., UE group ID or a network slice ID associated with a UE group) the AMF 230 has associated with the location/ranging request. The identifier associated with a UE group (e.g., ID) is added to LMF related NRF registration and discovery information stored in a NRF as defined in TS 29.510 Table 6.1.6.2.46-1: Definition of type LmfInfo. The network slice ID is an input parameter of Nnrf_NFManagement_NFRegister and of Nnrf_NFDiscovery_Request (210).

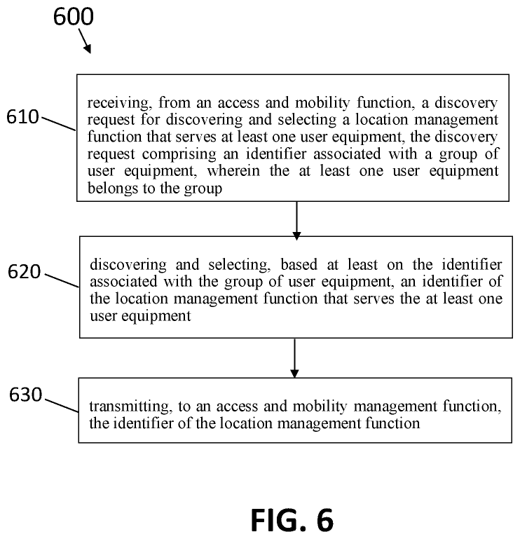

Steps 1 to 5 of the example of the MT-LR procedure shown in FIG. 2 are similar to steps 1 to 5 of the procedure shown in 3GPP TS 23.273 FIG. 6.1.2-1 and are thus not described in detail. However, the MT-LR procedure shown in FIG. 2 includes the following which are not part of the procedure shown in 3GPP TS 23.273 FIG. 6.1.2-1.

At 1a: For a LCS client 280 requests location or ranging services supported (or provided by) a LMF (e.g., LMF 240). To request location and ranging services supported (or provided) by a LMF, the LCS client 280, to the GMLC sends a location services (LCS) service request. The LCS service request may include an identifier associated with a target UE group (e.g., a group of user equipment including at least one user equipment for which a location is requested by the LCS client). The identifier associated with a target UE group may be a UE group ID of the target UE group or network slice ID associated with the target UE group (e.g., a network slice allowed that services the target UE group). In some examples, an AF may send to a network exposure function (NEF) of the wireless communication system (step 1b-1 (201-a), a request. The request may include information related to location service that the GMLC 260 or the NEF 290 can use to determine an identifier associated with a target UE group (e.g., the UE group ID of a target UE group or the network slice ID associated with the target UE group, and the determined identifier associated with the target UE group (e.g., the UE group ID of the target UE group) or the network slice ID is forwarded to AMF 230 at step 5 (205).

As an alternative, the LCS client 280 selects a GMLC 260 or NEF 290 that is dedicated to a service area for the location service and GMLC 260 or NEF 290 includes the identifier associated with target a UE group (e.g., a UE group ID of a target UE group that includes UEs located in the service area, or a network slice ID associated with a target UE group that includes UEs that are located in the service area in the request in step 5 (205).

As a second alternative, even if the AMF 230 received a location request (e.g., using Namf_Location_ProvidePositioningInfo (205) service operation for MT-LR) or AMF 230 received an MO-LR request from a UE (e.g., UE 110) as shown in TS 23.273 FIGS. 6.2-1 for a 5GC-MO-LR Procedure) where the MO-LR request does not contain an identifier associated with a target UE group (e.g., a UE group ID of a target UE group or a network slice ID associated with a target UE group), the AMF 230 may decide to consider an identifier associated with a target UE group (e.g., a UE group ID of a target UE group or a network slice ID associated with a target UE group) as applicable to the LCS request. The trigger for the AMF 230 to consider an identifier associated with a target UE group (e.g., a UE ID of a target UE group or a network slice ID associated with the target UE group) as applicable to a LCS request is defined herein.

At 4 (204): The GMLC 260 or NEF 290 may derive (or determine) group information (e.g., an identifier associated with the target UE group), from the listed items herein under the section Criteria of Group Correlation from AF and/or LCS Client Request Parameters.

For the location request for a location of a target UE included in a UE group, the location request includes a UE ID (SUPI) of the target UE/After having checked that the SUPI of a target UE has a subscription to the identifier associated with a target UE group (e.g., a UE group ID of the UE group that includes the target UE or that the target UE belongs to) or a network slice ID associated with a UE group that includes the target UE or that the target UE belongs) determined for the location request, the AMF 230 uses the identifier associated with the UE group (e.g., the UE group ID of the UE group that includes the target UE or that the target UE belongs to or a network slice ID associated with the UE group that includes the target UE or that the target UE belongs to) to discover and select a LMF 240 for the location request for the location of the target UE: the AMF 230 issues (e.g., sends) a Nnrf_NFDiscovery request (Step 10 (210)) towards NRF 250 that includes the identifier associated with the UE group (e.g., the target UE group ID that includes the target UE or that the target UE belongs to or a network slice ID associated with the target UE group that includes the target UE or that the target UE belongs to) as a discovery parameter.

If the SUPI of a target UE does not have a subscription to the UE group determined for the location request, the AMF 230 does not use the identifier associated with the UE group (e.g., UE group ID of the UE group or a network slice ID associated with the UE group) to discover and select a LMF (240) for the location request for the location of the target UE.

Regarding the trigger for the AMF 230 to consider an identifier associated with a UE group (e.g., a UE group ID of a UE group that includes the target UE or that the target UE belongs to or a network slice ID associated with a target UE group that includes the target UE or that the target UE belongs to) as applicable to a LCS request, a table associating tracking areas and/or cells (e.g., identifiers of tracking area and/or identifiers of cells) with the identifier associated with the UE group (e.g., the UE group ID of the UE group that includes the target UE or that the target UE belongs to or a network slice ID associated with the UE group that includes the target UE or that the target UE belongs to) is stored at the core network. This table could be stored at and managed by the NRF 250. If a UE (e.g., UE 110) which is the subject of a location request (e.g., whose location is requested by a LCS client) is located in a tracking area associated with the identifier of the UE group (e.g., the UE ID of the UE group that includes the UE or that the UE belongs to a network slice ID associated with the UE group that includes the UE or that the UE belongs to) then the AMF 230 may consider the identifier associated with the UE group (e.g., the UE group ID of the UE group that includes the UE or that the UE belongs to or a network slice ID associated with the UE group that includes the UE or that the UE belongs to) as applicable to a LCS request.

Accordingly, as shown in FIG. 2, at 201-a the LCS client 280 transmits an LCS service request to GMLC 260. At 201-b1 the AF 295 transmits, to the NEF 290, a subscription request (e.g., by invoking a Nnef_EventExposure_Subscribe service operation). At 201-b2, the NEF 290 transmits a location request (e.g., Ngmlc_Location_ProvideLocation Request) to GMLC 260. At 202, I GMLC 260 sends, to the UDM 270, a request for subscriber data for the at least one user equipment and receives, from the UDM 270, the subscriber data for the at least one user equipment. At 203, the GMLC 260, sends a request for participate in a user equipment centric mobility exchange. At 204, the NEF 290 or the GMLC 260 derives (or determines) an identifier associated with a UE group (e.g., a UE group ID or a network slice ID associated with the UE group) for the location request.

At 205, the GMLC 260 transmits a positioning information request (e.g., invokes a Namf_Location_ProvidePositioningInfo service operation to send a positioning information request) to the AMF 230, where the positioning information request is a request for a location of the at least one user equipment (i.e., a location request for a location of the at least one user equipment). At 206, if the UE 110 is in CM IDLE state, the AMF 230 initiates a network triggered service request procedure as defined in clause 4.2.3.3 of TS 23.502 to establish a signaling connection with the UE 110. At 207, the AMF 230 transmits, to the UE 110, a NAS location notification invoke message, an identity of the LCS client, indicating the Requestor Identity (if that is both supported and available) and whether privacy verification is required. At 208, the UE 110 transmits, to the AMF 230, an NAS location notification result indicating, if privacy verification was requested, whether permission is granted or denied for the current LCS request. At 209, the AMF 230 invokes the Nudm_ParameterProvision_Update (LCS privacy) service operation to store in the UDM 270 the Location Privacy Indication information received from the UE 110. The UDM 270 may then store the updated UE privacy setting information into the UDR (not shown) as the “LCS privacy” Data Subset of the subscription data.

At 210, the AMF transmits an LMF selection with group information to the NRF 250. At 211, the AMF 230 transmits an LMF location determine location request (e.g., Nlmf_Location_DetermineLocation Request) to LMF 240. At 212, UE 110, NG_RAN node 170, AMF 230, and LMF 240 participate in UE positioning. At 213, the LMF 240 transmits a response to the location determine location response (e.g., Nlmf_Location_DetermineLocation Response) to the AMF 230. At 214, the AMF 230 transmits an AMF location provide positioning information response (e.g., Namf_Location_ProvidePositioningInfo Response) to the GMLC 260, in response to the message transmitted at 205.

At 216, the GMLC 260 initiates a privacy check. At 218, the GMLC 260 transmits an AMF location provide positioning information request (e.g., Namf_Location_ProvidePositioningInfo Request) to the AMF 230. At 219, the UE 110, NG-RAN 170, and AMF 230 initiate a network triggered service request. At 220, the AMF 230 transmits an NAS location notification invoke request to the UE 110. At 221, the UE 110 transmits an NAS location notification return result to the AMF 230, in response to the message sent at 220. At 223, the AMF 230 transmits a GMLC location provide location response to the GMLC 260, in response to the message transmitted at 218. At 224-a, the GMLC 260 transmits an LCS service response message to the LCS client 280, in response to the message transmitted at 201-a. At 224-b1, the GMLC 260 transmits a GMLC location provide location response message (e.g., Ngmlc_Location_ProvideLocation Response) to the NEF 290, in response to the message transmitted at 201-b2. At 224-b2, the NEF 290 transmits an NEF event exposure notify message (e.g., Nnef_EventExposure_Notify) to AF 295, for example in response to message 201-b1.

The GMLC 260 may be configured with the following parameters: LMF ID and/or per group ID and its correlating LMF ID. The AMF 230 may use a locally provisioned configuration to determine the LMF 240 based on UE identity or its group information. It is AMF implementation specific for the application or determination of priority of different selection criteria based on information received from or for the GMLC 260, AMF 230 and LMF 240. When the GMLC 260 receives a MT location request from the LCS client 280 or AF 295, the GMLC 260 determines the LMF ID based on the configured parameters for the LCS client 280 or AF 295. In case a group ID is provided or derived from the location request, GMLC 260 determines the correlating LMF ID based on the provisioned group ID.

Criteria of Group Correlation from AF/LCS Client Request Parameters:

AMF 230 has several GMLC and/or LMF correlation criteria, based on URI for GMLC (referred to hereinafter as GMLC URI), LMF identifier (“LMF Id”), client type, etc. For group correlation (where group correlation corresponds to determining an identifier associated with a UE Group, such as a UE group ID or a network slice ID associated with a UE group, the following information is transferred from the AF 295 or the LCS Client 280 to the AMF 230 and used by AMF 230 as group correlation criteria (1-7 as follows):
1. AF 295 may transfer or provide an identifier associated with a UE ((referred to as ExternalGroupID) to AMF 230 via GMLC 260 or NEF 290, for example, using Ngmlc_Location_ProvideLocation service operation defined in TS 23.273 clause 8.4.2 either by performing whole group positioning or bulk positioning (in which case a UE group ID is already supported as a request parameter) or a positioning request for a UE included in the group of UEs identified by the UE group ID, where a UE group ID is also provided by the LCS client 280 in the positioning request.
2. The ServiceIdentity or Serviceid included in the location/ranging request (e.g., a request for a location or a range for a UE) sent by the AF 295 or LCS Client 280 (e.g., Service type in Ngmlc_Location_ProvideLocation service operation defined in TS 23.273 clause 8.4.2) could be used to derive (or determine) an identifier associated with a UE group (e.g. a UE group ID or a network slice ID associated with a UE group) for the location and/or ranging request). The NEF 290 or GMLC 260 can derive (or determine) an identifier associated with a UE group (e.g., the UE group ID of a UE group or the network slice ID associated with a UE group) from the Serviceid from the request for forwarding to AMF 230.
3. Information associated with a coverage area for the location service (e.g., service coverage parameter) included in the location services service request is within or the same as the ProSc/Ranging service of the certain area. The NEF 290 or GMLC 260 can derive (or determine) the area information indicative of a service coverage area for the location service from the service coverage parameter included in the service request and forward the information indicative of the service coverage to AMF 230.
4. By the profile of the AF and/or LCS client which can be correlated by AF client connection, or ExternalClientIdentification included in the LCS request. The AF 295 or LCS Client 280 may be correlated to the GMLC instances by its profile settings. The NEF 290 or GMLC 260 can derive (or determine) the identifier associated with a UE group (e.g., the UE group ID or network slice ID) from the AF and/or LCS client information included in the location services service request (e.g., LCS Client Identification in Ngmlc_Location_ProvideLocation service operation defined in TS 23.273 clause 8.4.2) and forward the derived (or determined) identifier associated with a UE group (e.g., UE group ID or a network slice ID) to AMF 230.
5. Service type included in the LCS service request shows ‘Location Based Information Services’.

New parameters can also be considered in this logic:
6. Network slice ID associated with a UE group could be provided in the request or determined by GMLC 260 or NEF 290 or AMF 230 and used by the AMF 230 for the LMF selection.
7. GMLC 260 and/or NEF 290 and/or AMF 230 may be used for a service area or service group of the LMF instance. UE group ID of a UE group or a network slice ID associated with a UE group can be deduced (or determined) from its profile settings e.g. profile settings of the GMLC 260, NEF 290, or AMF 230.

In summary, group correlation logic in AMF 230 (where group correlation logic is configured to determine an identifier associated with a UE group (e.g., a UE group ID of a UE group, a network slice ID associated with a UE group), or other group information, or a UE group based on associated group information) can get the information that is used to determine an identifier associated with a UE group: 1. from direct input from AF 295 or LCS Client 280 included in the location request (e.g. request 205), or 2. Can be determined by GMLC 260 or NEF 290 from the above listed parameters from AF 295 or LCS Client 280 included in the request (e.g. request 205).

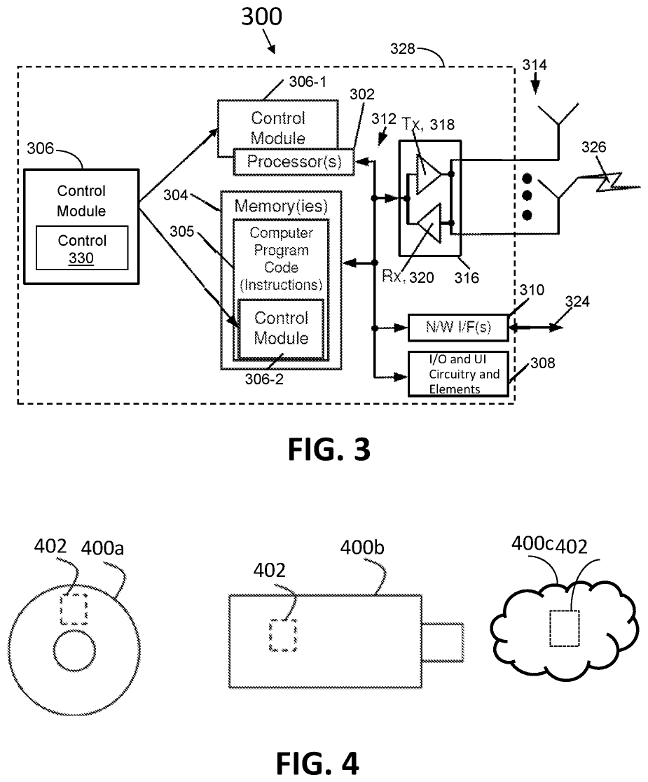

FIG. 3 is an example apparatus 300, which may be implemented in hardware, configured to implement the examples described herein. The apparatus 300 comprises at least one processor 302 (e.g. a CPU, a GPU, a TPU, a microprocessor, a multi-core microprocess, an FPGA, and/or an ASIC.), one or more memories 304 including computer program code 305, the computer program code 305 having instructions to carry out the methods described herein, wherein the at least one memory 304 and the computer program code 305 are configured to, with the at least one processor 302, cause the apparatus 300 to implement circuitry, a process, component, module, or function (implemented with control module 306) to implement the examples described herein, including using an identifier associated with a group of user equipment to select a LMF for determining a location of a user equipment that belongs to the group of user equipment. Control 330 of the control module 306 may perform the operations described herein including using the identifier associated with a group of user equipment to select a LMF for determining a location of a user equipment that belongs to the group of user equipment. The memory 304 may be a non-transitory memory, a transitory memory, a volatile memory (e.g., RAM), or a non-volatile memory (e.g., ROM).

In some embodiments, the apparatus 300 is UE 110 and the apparatus 300 includes a display and/or I/O interface 308, which includes user interface (UI) circuitry and elements, that may be used to display information, or to receive input from a user such as with using a keypad, camera, touchscreen, touch area, microphone, biometric recognition, one or more sensors, etc. The apparatus 300 includes one or more communication e.g., network (N/W) interfaces (I/F(s)) 310. The communication I/F(s) 310 may be wired and/or wireless and communicate over the Internet/other network(s) via any communication technique including via one or more links 324. The link(s) 324 may be the link(s) 131 and/or 176 from FIG. 1. The link(s) 131 and/or 176 from FIG. 1 may also be implemented using transceiver(s) 316 and corresponding wireless link(s) 326. The communication I/F(s) 310 may comprise one or more transmitters or one or more receivers.

In some embodiments, the apparatus 300 is UE 110 or RAN node 170 and includes the transceiver 316 that comprises one or more transmitters 318 and one or more receivers 320. The transceiver 316 and/or communication I/F(s) 310 may comprise standard well-known components such as an amplifier, filter, frequency-converter, (de) modulator, and encoder/decoder circuitries and one or more antennas, such as antennas 314 used for communication over wireless link 326.

The control module 306 of the apparatus 300 comprises one of or both parts 306-1 and/or 306-2, which may be implemented in a number of ways. The control module 306 may be implemented in hardware as control module 306-1, such as being implemented as part of the one or more processors 302. The control module 306-1 may be implemented also as an integrated circuit or through other hardware such as a programmable gate array. In another example, the control module 306 may be implemented as control module 306-2, which is implemented as computer program code (having corresponding instructions) 305 and is executed by the one or more processors 302. For instance, the one or more memories 304 store instructions that, when executed by the one or more processors 302, cause the apparatus 300 to perform one or more of the operations as described herein. Furthermore, the one or more processors 302, one or more memories 304, and example algorithms (e.g., as flowcharts and/or signaling diagrams), encoded as instructions, programs, or code, are means for causing performance of the operations described herein.

The apparatus 300 to implement the functionality of control 306 may be UE 110, RAN node 170 (e.g., gNB), or network element(s) 190. Thus, processor 302 may correspond to processor(s) 120, processor(s) 152 and/or processor(s) 175, memory 304 may correspond to one or more memories 125, one or more memories 155 and/or one or more memories 171, computer program code 305 may correspond to computer program code 123, computer program code 153, and/or computer program code 173, control module 306 may correspond to module 140-1, module 140-2, module 150-1, and/or module 150-2, and communication I/F(s) 310 and/or transceiver 316 may correspond to transceiver 130, antenna(s) 128, transceiver 160, antenna(s) 158, N/W I/F(s) 161, and/or N/W I/F(s) 180. Alternatively, apparatus 300 and its elements may not correspond to either of UE 110, RAN node 170, or network element(s) 190 and their respective elements, as apparatus 300 may be part of a self-organizing/optimizing network (SON) node or other node, such as a node in a cloud computing system. Apparatus 300 may also correspond to any of the other apparatuses depicted in FIG. 2.

The apparatus 300 may be distributed throughout the network (e.g., network 100) including within and between apparatus 300 and any network element 190 and/or the RAN node 170 and/or the UE 110 and/or any of the apparatuses depicted in FIG. 1.

Interface 312 enables data communication and signaling between the various items of apparatus 300, as shown in FIG. 3. For example, the interface 312 may be one or more buses such as address, data, or control buses, and may include any interconnection mechanism, such as a series of lines on a motherboard or integrated circuit, fiber optics or other optical communication equipment, and the like. Computer program code (e.g. instructions) 305, including control 306 may comprise object-oriented software configured to pass data or messages between objects within computer program code 305. The apparatus 300 need not comprise each of the features mentioned, or may comprise other features as well. The various components of apparatus 300 may at least partially reside in a common housing 328, or a subset of the various components of apparatus 300 may at least partially be located in different housings, which different housings may include housing 328.

FIG. 4 shows a schematic representation of non-volatile memory media 400a (e.g., computer/compact disc (CD) or digital versatile disc (DVD)), 400b (e.g., universal serial bus (USB) memory stick), and 400c (e.g., cloud storage) storing instructions and/or parameters 402 which when executed by a processor allows the processor to perform one or more of the steps of the methods (e.g., methods 500, 600, 700, 800, 900) described herein.

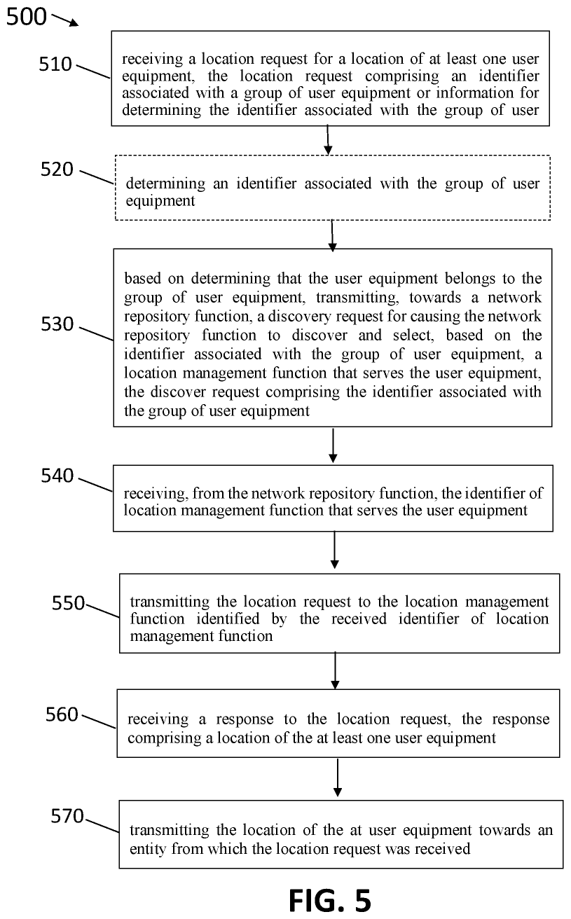

FIG. 5 is an example method 500, based on the example embodiments described herein. The method 500 begins at 510. At 510, the method 500 includes receiving a location request for a location of at least one user equipment, the location request comprising an identifier associated with a group of user equipment or information for determining the identifier associated with the group of user equipment (e.g., information be used to determine the identifier associated with a group of user equipment). The identifier associated with a group of user equipment may be a user equipment group identifier or a network slice identifier associated with the group of user equipment. The method 500 proceeds to directly to 530 when the location request comprising an identifier associated with a group of user equipment or proceeds to 520 when the location request comprises information for determining the identifier associated with the group of user equipment. At 520, when the location request comprises information for determining the identifier associated with the group of user equipment, the method 500 includes determining an identifier associated with the group of user equipment. In some embodiments, the information for determining the identifier associated with the group of user equipment may include an identifier of a cell (hereinafter referred to a cell identifier) that identifies a cell serving the group of user equipment and the method 500 determines, at 520, the identifier associated with the group of user equipment based on the cell identifier that identifies a cell serving the group of user equipment. In some embodiments, the information for determining the identifier associated with the group of user equipment may include an identifier of a tracking (hereinafter referred to a tracking area identifier) that identifies a tracking area serving or for the group of user equipment and the method 500 determines, at 520, the identifier associated with the group of user equipment based on tracking area identifier that identifies a tracking area serving or for the group of user equipment. At 530, the method 500 includes based on determining that the at least one user equipment belongs to the group of user equipment, transmitting, towards a network repository function, a discovery request for causing the network repository function to discover and select, based on the identifier associated with the group of user equipment, a location management function that serves the user equipment, the discover request comprising the identifier associated with the group of user equipment. In some embodiments, the location request further comprises an identifier of the least one user equipment, and the determining that the at least one user equipment belongs to the group of user equipment comprises determining that the identifier of the user equipment has a subscription to the identifier of associated with the group of user equipment. At 540, the method 500 includes receiving, from the network repository function, the identifier of location management function that serves the user equipment. In some embodiments, the identifier of the location management function is received in a response to the discovery request transmitted by the network repository function. At 550, the method 500 includes transmitting the location request to the location management function identified by the received identifier of location management function. At 560, the method 500 includes receiving a response to the location request, the response comprising a location of the at least one user equipment. At 570, the method 500 includes transmitting the location of the at user equipment towards an entity from which the location request was received. Method 500 may be performed by AMF 230, a network element 190, or apparatus 300. For example, in some embodiments, a network element 190 may comprise computer program code 173 implementing an AMF, and the computer program code 173 has instructions that, when executed by the processor(s) 175 of the network element 190, cause the network element 190 to carry out or perform the method 500. In some other embodiments, the apparatus 300 may include computer program code 305 implementing an AMF and the computer program code 305 has instructions that, when executed by the processor(s) 302 cause the apparatus 300 to carry out or perform the method 500.

FIG. 6 is an example method 600, based on the example embodiments described herein. At 610, the method 600 includes receiving, from an access and mobility function, a discovery request for discovering and selecting a location management function that serves at least one user equipment, the discovery request comprising an identifier associated with a group of user equipment, wherein the at least one user equipment belongs to the group. The identifier associated with a group of user equipment may be a user equipment group identifier or a network slice identifier associated with the group of user equipment. At 620, the method 600 includes discovering and selecting, based at least on the identifier associated with the group of user equipment, an identifier of the location management function that serves the user equipment. In some embodiments, the discovery and selecting is further based on information associated with the location management function that serves the at least one user equipment. The information associated with the location management function that serves the at least one user equipment may comprise the identifier associated with the group of user equipment and the identifier of the location management function. In some embodiments, the information associated with the location management function may be location management function related NRF registration and discovery information as described above (otherwise referred to as LmfInfo) which includes the identifier associated with a group of user equipment. At 630, the method 660 includes transmitting, to an access and mobility management function, the identifier of the location management function. Method 600 may be performed by a repository (e.g., NRF 250 of a core network 190), a network element 190, or apparatus 300 that stores the information associated with the location management function that serves the at least one user equipment. For example, in some embodiments, a network element 190 may comprise computer program code 173 implementing a repository (e.g., NRF 250), and the computer program code 173 has instructions that, when executed by the processor(s) 175 of the network element 190, cause the network element 190 to carry out or perform the method 600. In some other embodiments, the apparatus 300 may include computer program code 305 implementing a repository (e.g., NRF 250) and the computer program code 305 has instructions that, when executed by the processor(s) 302 cause the apparatus 300 to carry out or perform the method 600.

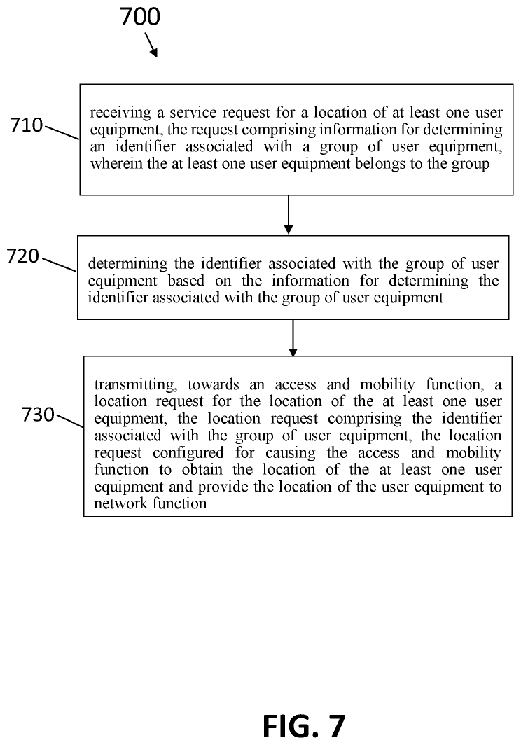

FIG. 7 is an example method 700, based on the example embodiments described herein. At 710, the method 700 includes receiving a service request for a location of at least one user equipment, the request comprising information for determining an identifier associated with a group of user equipment, wherein the at least one user equipment belongs to the group. The service request may be a service request for a location service provided by a gateway mobile location center, the service request may be received from a location services client or an application function via a network exposure function, and the location service may provide a location of the at least one user equipment to the gateway mobile location center or the application function which sent the service request. At 720, the method 700 includes determining the identifier associated with the group of user equipment based on the information for determining the identifier associated with the group of user equipment. In some embodiments, the information for determining the identifier associated with the group of user equipment comprises at least one of a service identity that identifies the location service, information associated with a service area for the location service, a service type associated with the location service, information associated with the location services client; a gateway location mobile center profile of the gateway mobile location center, or the network exposure function profile of the a network exposure function In some embodiments, the identifier associated with a group of user equipment may be a user equipment group identifier or a network slice identifier associated with the group of user equipment. At 730, the method 700 includes transmitting, towards an access and mobility function, a location request for the location of the at least one user equipment, wherein the location request comprising the identifier associated with the group of user equipment. The location request is configured for causing the access and mobility function to obtain the location of the at least one user equipment and provide the location of the at least one user equipment to network function. In some embodiments, the method 700 further comprises receiving a response to the location request and the response includes the location of the at least one user equipment. In some embodiments, the method 700 further comprises transmitting a response to the service request which comprises the location of the at least one user equipment. Method 700 may be performed by GMLC 260 or NEF 290, a network element 190, or apparatus 300. For example, in some embodiments, a network element 190 may comprise computer program code 173 implementing a GMLC 260 or NEF 290, and the computer program code 173 has instructions that, when executed by the processor(s) 175 of the network element 190, cause the network element 190 to carry out or perform the method 700. In some other embodiments, the apparatus 300 may include computer program code 305 implementing GMLC 260 or NEF 290 and the computer program code 305 has instructions that, when executed by the processor(s) 302 cause the apparatus 300 to carry out or perform the method 700.

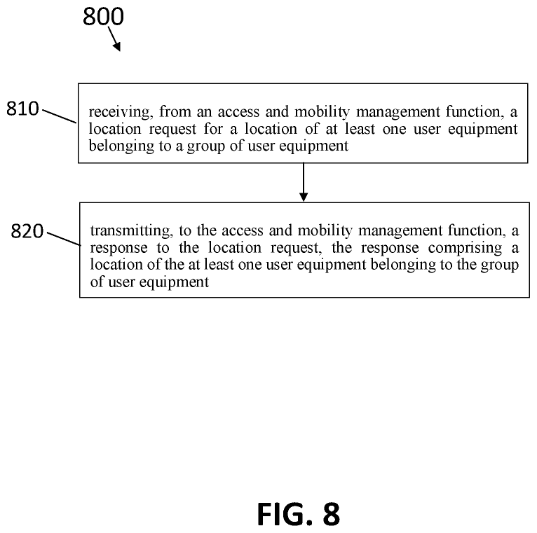

FIG. 8 is an example method 800, based on the example embodiments described herein. At 810, the method 800 includes receiving, from an access and mobility management function, a location request for a location of at least one user equipment belonging to a group of user equipment. At 820, the method 800 includes transmitting, to the access and mobility management function, a response to the location request, the response comprising a location of the at least one user equipment belonging to the group of user equipment. Method 800 may be performed with LMF 240, a network element 190, or apparatus 300. For example, in some embodiments, a network element 190 may comprise computer program code 173 implementing a LMF (e.g., LMF 240), and the computer program code 173 has instructions that, when executed by the processor(s) 175 of the network element 190, cause the network element 190 to carry out or perform the method 800. In some other embodiments, the apparatus 300 may include computer program code 305 implementing a LMF (e.g., LMF 240) and the computer program code 305 has instructions that, when executed by the processor(s) 302 cause the apparatus 300 to carry out or perform the method 800.

The following examples are provided and described herein.

Example 1. An apparatus including: at least one processor; and at least one memory storing instructions that, when executed by the at least one processor, cause the apparatus at least to: receiving a location request for a location of at least one user equipment, the location request comprising an identifier associated with a group of user equipment or information for determining the identifier associated with the group of user equipment; based on determining that the at least one user equipment belongs to the group of user equipment, transmitting, towards a network repository function, a discovery request for causing the network repository function to discover and select, based on the identifier associated with the group of user equipment, a location management function that serves the at least one user equipment, the discover request comprising the identifier associated with the group of user equipment; and receiving, from the network repository function, the identifier of location management function that serves the user equipment.

Example 2. The apparatus of example 1, wherein the instructions, when executed by the at least one processor, cause the apparatus at least to: transmitting the location request to the location management function identified by the received identifier of location management function; receiving a response to the location request, the response comprising a location of the at least one user equipment; and transmitting the location of the at user equipment towards an entity from which the location request was received, wherein the entity is a gateway mobile location center or a user equipment of the at least one user equipment.

Example 3. The apparatus of example 1 or 2, wherein the location request comprises information for determining the identifier associated with the group of user equipment, and wherein the information comprises a tracking area identifier, and wherein the instructions that, when executed by the at least one processor, further cause the apparatus at least to determine the identifier associated with the group of user equipment based on the tracking area identifier.

Example 4. The apparatus of example 1 or 2, wherein the location request comprises information for determining the identifier associated with the group of user equipment, and wherein the information comprises a cell identifier, and wherein the instructions that, when executed by the at least one processor, further cause the apparatus at least to determine the identifier associated with the group of user equipment based on the cell identifier.

Example 5. The apparatus of any of examples 1 to 4, wherein the identifier of the location management function is received in a response to the discovery request transmitted by the network repository function.

Example 6. The apparatus of any of examples 1 to 5, wherein the identifier associated with the group of user equipment comprises a network slice identifier that identifies a network slice associated with the group of user equipment.

Example 7. The apparatus of any of examples 1 to 5, wherein the identifier associated with the group of user equipment comprises a user equipment group identifier that identifies the group of the user equipment.

Example 8. The apparatus of any of examples 1 to 7, wherein the location request further comprises an identifier of the user equipment, and wherein determining that the user equipment belongs to the group of user equipment comprises determining that the identifier of the user equipment has a subscription to the identifier of associated with the group of user equipment.

Example 9. An apparatus including: at least one processor; and at least one memory storing instructions that, when executed by the at least one processor, cause the apparatus at least to: receiving, from an access and mobility function, a discovery request for discovering and selecting a location management function that serves at least one user equipment, the discovery request comprising an identifier associated with a group of user equipment, wherein the at least one user equipment belongs to the group; and discovering and selecting, based at least on the identifier associated with the group of user equipment, an identifier of the location management function that serves the at least one user equipment; transmitting, to an access and mobility management function, the identifier of the location management function.

Example 10. The apparatus of example 9, wherein the apparatus stores information associated with the location management function, wherein the information comprises the identifier associated with the group of user equipment and the identifier of the location management function.

Example 11. The apparatus of example 10, wherein the discovery and selecting is further based on the information associated with the location management function that serves the at least one user equipment.

Example 12. The apparatus of any of claims 9 to 11, wherein the identifier associated with the group of user equipment comprises a network slice identifier that identifies a network slice that is associated with the group of the user equipment.

Example 13. The apparatus of claims 9 to 11, wherein the identifier associated with the group of user equipment comprises a user equipment group identifier that identifies the group of the user equipment.

Example 14. The apparatus of any of claims 9 to 13, wherein the information comprises one or more identifiers associated with one or more groups of user equipment and one or more identifiers of one or more location management functions, wherein the one or more identifiers associated with the one or more groups of user equipment comprises the identifier associated with the group of user equipment, wherein one or more identifiers of one or more location management functions.

Example 15. An apparatus including: at least one processor; and at least one memory storing instructions that, when executed by the at least one processor, cause the apparatus at least to: receiving a service request for a location of at least one user equipment, the request comprising information for determining an identifier associated with a group of user equipment, wherein the at least one user equipment belongs to the group; determining the identifier associated with the group of user equipment based on the information for determining the identifier associated with the group of user equipment; and transmitting, towards an access and mobility function, a location request for the location of the at least one user equipment, the location request comprising the identifier associated with the group of user equipment, the location request configured for causing the access and mobility function to obtain the location of the at least one user equipment and provide the location of the at least one user equipment to network function.

Example 16. The apparatus of example 15, wherein the instructions, when executed by the at least one processor, cause the network function to perform the operation comprising: receiving a response to the location request, the response comprising the location of the at least one user equipment; and transmitting a response to the service request, the response to the service request comprising the location of the at least one user equipment.

Example 17. The apparatus of example 16, wherein the service request is received from a location services client, and wherein the response to the service request is transmitted to the location services client.

Example 18. The apparatus of example 17, wherein the information for determining the identifier associated with the group of user equipment comprises at least one of the following: a service identity that identifies the location service; information associated with a service area for the location service; a service type associated with the location service; information associated with the location services client; or a gateway location mobile center profile of a gateway mobile location center.

Example 19. The apparatus of example 16, wherein the service request is received from an application function via a network exposure function and wherein the response is transmitted to the application function via the network exposure function.

Example 20. The apparatus of example 19, wherein the information for determining an identifier associated with a group of user equipment comprises at least one of the following: a service identifier that identifies the location service; information associated with a coverage area for the location service; information associated with the application function; a service type associated with the location service; a gateway mobile location center profile of a gateway mobile location center; or a network exposure function profile of a network exposure function.

Example 21. The apparatus of any of examples 15 to 20, wherein the identifier associated with the group of user equipment comprises a network slice identifier that identifies a network slice associated with the group of user equipment.

Example 22. The apparatus of any of examples 15 to 20, wherein the identifier associated with the group of user equipment comprises a group identifier that identifies the group of the at least one user equipment.

Example 23. A method for an access and mobility function, the method including: receiving, by an access and mobility function, a location request for a location of at least one user equipment, the location request comprising an identifier associated with a group of user equipment or information for determining the identifier associated with the group of user equipment; based on determining, by an access and mobility function, that the at least one user equipment belongs to the group of user equipment, transmitting, by an access and mobility function towards a network repository function, a discovery request for causing the network repository function to discover and select, based on the identifier associated with the group of user equipment, a location management function that serves the at least one user equipment, the discover request comprising the identifier associated with the group of user equipment; and receiving, by an access and mobility function, from the network repository function, the identifier of location management function that serves the user equipment.

Example 24. A method including for a network repository function, the method including: receiving, by the network repository function from an access and mobility function, a discovery request for discovering and selecting a location management function that serves at least one user equipment, the discovery request comprising an identifier associated with a group of user equipment, wherein the at least one user equipment belongs to the group; and discovering and selecting by the network repository function, based at least on the identifier associated with the group of user equipment, an identifier of the location management function that serves the at least one user equipment; transmitting, by the network repository function to an access and mobility management function, the identifier of the location management function

Example 25. A method for a network entity, the method comprising: receiving, by the network entity, a service request for a location of at least one user equipment, the request comprising information for determining an identifier associated with a group of user equipment, wherein the at least one user equipment belongs to the group; determining, by the network entity, the identifier associated with the group of user equipment based on the information for determining the identifier associated with the group of user equipment; and transmitting, by the network entity, towards an access and mobility function, a location request for the location of the at least one user equipment, the location request comprising the identifier associated with the group of user equipment, the location request configured for causing the access and mobility function to obtain the location of the at least one user equipment and provide the location of the at least one user equipment to network function, wherein the network entity is a gateway location mobile center or a network exposure function.

Example 26. An apparatus including: means for providing an access and mobility function configured to perform the operations of: receiving a location request for a location of at least one user equipment, the location request comprising an identifier associated with a group of user equipment or information for determining the identifier associated with the group of user equipment; based on determining that the at least one user equipment belongs to the group of user equipment, transmitting, towards a network repository function, a discovery request for causing the network repository function to discover and select, based on the identifier associated with the group of user equipment, a location management function that serves the at least one user equipment, the discover request comprising the identifier associated with the group of user equipment; and receiving, from the network repository function, the identifier of location management function that serves the user equipment.

Example 27. An apparatus including: means for providing a network repository function configured to perform the operations of: receiving, from an access and mobility function, a discovery request for discovering and selecting a location management function that serves at least one user equipment, the discovery request comprising an identifier associated with a group of user equipment, wherein the at least one user equipment belongs to the group; and discovering and selecting, based at least on the identifier associated with the group of user equipment, an identifier of the location management function that serves the at least one user equipment; transmitting, to an access and mobility management function, the identifier of the location management function.

Example 28. An apparatus including: means for a network entity configure to perform the operations of: receiving a service request for a location of at least one user equipment, the request comprising information for determining an identifier associated with a group of user equipment, wherein the at least one user equipment belongs to the group; determining the identifier associated with the group of user equipment based on the information for determining the identifier associated with the group of user equipment; and transmitting towards an access and mobility function, a location request for the location of the at least one user equipment, the location request comprising the identifier associated with the group of user equipment, the location request configured for causing the access and mobility function to obtain the location of the at least one user equipment and provide the location of the at least one user equipment to network function, wherein the network entity is a gateway location mobile center or a network exposure function.

Example 29. A non-transitory program storage device readable by a machine, tangibly embodying a program of instructions executable by the machine for performing operations, the operations including: receiving a location request for a location of at least one user equipment, the location request comprising an identifier associated with a group of user equipment or information for determining the identifier associated with the group of user equipment; based on determining that the at least one user equipment belongs to the group of user equipment, transmitting, towards a network repository function, a discovery request for causing the network repository function to discover and select, based on the identifier associated with the group of user equipment, a location management function that serves the at least one user equipment, the discover request comprising the identifier associated with the group of user equipment; and receiving, from the network repository function, the identifier of location management function that serves the user equipment.

Example 30. A non-transitory program storage device readable by a machine, tangibly embodying a program of instructions executable by the machine for performing operations, the operations including: receiving, from an access and mobility function, a discovery request for discovering and selecting a location management function that serves at least one user equipment, the discovery request comprising an identifier associated with a group of user equipment, wherein the at least one user equipment belongs to the group; and discovering and selecting, based at least on the identifier associated with the group of user equipment, an identifier of the location management function that serves the at least one user equipment; transmitting, to an access and mobility management function, the identifier of the location management function.

Example 31. A non-transitory program storage device readable by a machine, tangibly embodying a program of instructions executable by the machine for performing operations, the operations including: receiving a service request for a location of at least one user equipment, the request comprising information for determining an identifier associated with a group of user equipment, wherein the at least one user equipment belongs to the group; determining the identifier associated with the group of user equipment based on the information for determining the identifier associated with the group of user equipment; and transmitting towards an access and mobility function, a location request for the location of the at least one user equipment, the location request comprising the identifier associated with the group of user equipment, the location request configured for causing the access and mobility function to obtain the location of the at least one user equipment and provide the location of the at least one user equipment to network function, wherein the network entity is a gateway location mobile center or a network exposure function.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g., a dash, hyphen, slash, or number, and may be case insensitive (e.g., ID and id each correspond to identifier)):
3GPP third generation partnership project
4G fourth generation
5G fifth generation
5GC 5G core network
AF application function
AMF access and mobility management function
ASIC application-specific integrated circuit
CD compact/computer disc
CPU central processing unit
CU central unit or centralized unit
DSP digital signal processor
DVD digital versatile disc
eLCS enhanced location services
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FPGA field-programmable gate array
GMLC gateway mobile location center
gNB base station for 5G/NR, i.e., a node providing NR user plane and control plane protocol terminations towards the UE, and connected via the NG interface to the 5GC
IAB integrated access and backhaul
ID identifier
I/F interface
I/O input/output
KI key issue
LCS location services
LMF location management function
LTE long term evolution (4G)
MAC medium access control
MME mobility management entity
MO-LR mobile originated location request
MT-LR mobile terminated location request
MRO mobility robustness optimization
NAS non-access stratum
NCE network control element
NEF network exposure function
NF network function
ng or NG new generation
ng-eNB new generation eNB
NG-RAN new generation radio access network
Namf service-based interface for the access and mobility management function
Ngmlc service based interface for the GMLC
Nlmf service based interface for the LMF
Nnef NEF service based interface
Nnrf service based interface for the NRF
Nudm service based interface for unified data management
NR new radio
NRF network repository function
N/W network
OAM operations, administration and maintenance
PDA personal digital assistant
PDCP packet data convergence protocol
PHY physical layer
R release (e.g. R18)
RAM random access memory
RAN radio access network
Rel release
RLC radio link control
ROM read-only memory
RRC radio resource control
RU radio unit
Rx receiver or reception
SDAP service data adaptation protocol
SDM subscriber data management
SGW serving gateway
SMF session management function
S-NSSAI single network slice selection assistance information
SNR signal to noise ratio
SON self-organizing/optimizing network
SUPI subscriber permanent identifier
TR technical report
TRP transmission reception point
TS technical specification
Tx transmitter or transmission
UAV unmanned aerial vehicle
UDM unified data management
UE user equipment (e.g., a wireless, typically mobile device)
UECM UE context management
UI user interface
UMTS universal mobile telecommunications system
UPF user plane function
URI uniform resource identifier
USB universal serial bus
UTRA UMTS terrestrial radio access
UTRAN UMTS terrestrial radio access network
X2 network interface between RAN nodes and between RAN and the core network
Xn network interface between NG-RAN nodes

What is claimed is:

1. An apparatus comprising:
at least one processor; and
at least one memory storing instructions that, when executed by the at least one processor, cause the apparatus to perform:
receiving a location request for a location of at least one user equipment, the location request comprising an identifier associated with a group of user equipment or information for determining the identifier associated with the group of user equipment;
based on determining that the at least one user equipment belongs to the group of user equipment, transmitting, towards a network repository function, a discovery request for causing the network repository function to discover and select, based on the identifier associated with the group of user equipment, a location management function that serves the at least one user equipment, the discover request comprising the identifier associated with the group of user equipment; and
receiving, from the network repository function, the identifier of location management function that serves the user equipment.

2. The apparatus of claim 1, wherein the instructions, when executed by the at least one processor, cause the apparatus to perform at least:
transmitting the location request to the location management function identified by the received identifier of location management function;
receiving a response to the location request, the response comprising a location of the at least one user equipment; and
transmitting the location of the at user equipment towards an entity from which the location request was received, wherein the entity is a gateway mobile location center or a user equipment of the at least one user equipment.

3. The apparatus of claim 1, wherein the location request comprises information for determining the identifier associated with the group of user equipment, and wherein the information comprises a tracking area identifier, and wherein the instructions that, when executed by the at least one processor, further cause the apparatus at least to determine the identifier associated with the group of user equipment based on the tracking area identifier.

4. The apparatus of claim 1, wherein the location request comprises information for determining the identifier associated with the group of user equipment, and wherein the information comprises a cell identifier, and wherein the instructions that, when executed by the at least one processor, further cause the apparatus at least to determine the identifier associated with the group of user equipment based on the cell identifier.

5. The apparatus of claim 1, wherein the identifier of the location management function is received in a response to the discovery request transmitted by the network repository function.

6. The apparatus of claim 1, wherein the identifier associated with the group of user equipment comprises a network slice identifier that identifies a network slice associated with the group of user equipment.

7. The apparatus of claim 1, wherein the identifier associated with the group of user equipment comprises a user equipment group identifier that identifies the group of the user equipment.

8. The apparatus of claim 1, wherein the location request further comprises an identifier of the user equipment, and wherein determining that the user equipment belongs to the group of user equipment comprises determining that the identifier of the user equipment has a subscription to the identifier of associated with the group of user equipment.

9. An apparatus comprising:
at least one processor; and
at least one memory storing instructions that, when executed by the at least one processor, cause the apparatus to perform:
receiving, from an access and mobility function, a discovery request for discovering and selecting a location management function that serves at least one user equipment, the discovery request comprising an identifier associated with a group of user equipment, wherein the at least one user equipment belongs to the group; and
discovering and selecting, based at least on the identifier associated with the group of user equipment, an identifier of the location management function that serves the at least one user equipment;
transmitting, to an access and mobility management function, the identifier of the location management function.

10. The apparatus of claim 9, wherein the apparatus stores information associated with the location management function, wherein the information comprises the identifier associated with the group of user equipment and the identifier of the location management function.

11. The apparatus of claim 10, wherein the discovery and selecting is further based on the information associated with the location management function that serves the at least one user equipment.

12. The apparatus of claim 9, wherein the identifier associated with the group of user equipment comprises a network slice identifier that identifies a network slice that is associated with the group of the user equipment.

13. The apparatus of claim 9, wherein the identifier associated with the group of user equipment comprises a user equipment group identifier that identifies the group of the user equipment.

14. The apparatus of claim 9, wherein the information comprises one or more identifiers associated with one or more groups of user equipment and one or more identifiers of one or more location management functions, wherein the one or more identifiers associated with the one or more groups of user equipment comprises the identifier associated with the group of user equipment, wherein one or more identifiers of one or more location management functions comprises the identifier of the location management function.

15. An apparatus comprising:
at least one processor; and
at least one memory storing instructions that, when executed by the at least one processor, cause the apparatus to perform:
receiving a service request for a location of at least one user equipment, the request comprising information for determining an identifier associated with a group of user equipment, wherein the at least one user equipment belongs to the group;
determining the identifier associated with the group of user equipment based on the information for determining the identifier associated with the group of user equipment; and
transmitting, towards an access and mobility function, a location request for the location of the at least one user equipment, the location request comprising the identifier associated with the group of user equipment, the location request configured for causing the access and mobility function to obtain the location of the at least one user equipment and provide the location of the at least one user equipment to network function.

16. The apparatus of claim 15, wherein the instructions, when executed by the at least one processor, cause the network function to perform the operation comprising:
receiving a response to the location request, the response comprising the location of the at least one user equipment; and
transmitting a response to the service request, the response to the service request comprising the location of the at least one user equipment.

17. The apparatus of claim 16, wherein the service request is received from a location services client, and wherein the response to the service request is transmitted to the location services client.

18. The apparatus of claim 17, wherein the information for determining the identifier associated with the group of user equipment comprises at least one of the following:
a service identity that identifies the location service;
information associated with a service area for the location service;
a service type associated with the location service;
information associated with the location services client; or
a gateway location mobile center profile of a gateway mobile location center.

19. The apparatus of claim 16, wherein the service request is received from an application function via a network exposure function and wherein the response is transmitted to the application function via the network exposure function.

20. The apparatus of claim 19, wherein the information for determining an identifier associated with a group of user equipment comprises at least one of the following:
a service identifier that identifies the location service;
information associated with a coverage area for the location service;
information associated with the application function;
a service type associated with the location service;
a gateway mobile location center profile of a gateway mobile location center; or
a network exposure function profile of a network exposure function.

21. The apparatus of claim 15, wherein the identifier associated with the group of user equipment comprises a network slice identifier that identifies a network slice associated with the group of user equipment.

22. The apparatus of claim 15, wherein the identifier associated with the group of user equipment comprises a group identifier that identifies the group of the at least one user equipment.
